(19) United States
(12) Patent Application Publication
(10) Pub. No.: US 2021/0226828 A1
(43) Pub. Date: Jul. 22, 2021

(54) TRANSMITTER, NETWORK NODE, METHOD AND COMPUTER PROGRAM

(71) Applicant: Telefonaktiebolaget LM Ericsson (publ), Stockholm (SE)

(72) Inventors: Leif WILHELMSSON, Lund (SE); Luis Felipe DEL CARPIO VEGA, Espoo (FI); Rocco DI TARANTO, Lund (SE); Miguel LOPEZ, Solna (SE); Divya PEDDIREDDY, Göteborg (SE); Dennis SUNDMAN, Sollentuna (SE)

(21) Appl. No.: 16/755,501

(22) PCT Filed: Sep. 26, 2018
(86) PCT No.: PCT/EP2018/076087

§ 371 Date: Apr. 10, 2020

Related U.S. Application Data
(60) Provisional application No. 62/574,464, filed on Oct. 19, 2017.

(51) Int. Cl. H04L 27/04

(52) U.S. Cl. CPC H04L 27/04

(57) ABSTRACT

A transmitter is arranged to transmit binary information using a binary amplitude shift keying where information symbols are represented by a signal including a first power state and a second power state. The first power state has a higher signal power than the second power state. A ratio in powers between the first and second power states is below a first value. The ratio in powers between the first and second power states is above a second value such that the states are distinguishably decodable. A network node having such a transmitter, a corresponding method, and a computer program for implementing the method in a transmitter are also disclosed.

### TECHNICAL FIELD

The present disclosure generally relates to a transmitter, a network node, methods therefor, and computer programs for implementing the method. In particular, the disclosure relates to providing a wireless signal carrying binary information where the signal has improved properties.

### BACKGROUND

The telecommunications domain has often so forth been accompanied by a significant increase of electrical energy consumption. Demands on performance, such as spectral efficiency or data rate, have been met at the expense of more energy consumption. Advances in analogue and digital electronics have enabled development of low-cost, low-energy wireless nodes. However, energy consumption remains an issue for some applications. Idle mode listening is typically used by devices related to the field commonly referred to as Internet of Things, IoT. Idle mode listening impacts the overall energy consumption for the devices. This is particularly noticeable when the data traffic is very sporadic.

Energy reduction may for example be performed by an approach in which the devices are able to switch off a main radio frequency interface during inactive periods and to switch it on only if a communication demand occurs. For example, by using a wake-up radio, where a wake-up signal is sent by using a transmitter, received and decoded at the device, wherein the main radio is activated, significant energy consumption reduction may be achieved for many applications.

Furthermore, efforts to reduce energy consumption may be made at different levels such as medium access protocols by dynamically adapting the sleep and wake times of main radio protocols. Limited complexity signals and thus decoders for the intermittently presented control signals may improve energy efficiency.

These efforts affect the physical layer, where control mechanisms for activation or deactivation of more energy consuming operations reside, which put demands on lean control signalling.

### SUMMARY

This disclosure is based on the inventors' understanding that lean signalling benefits from low-complex signals. This disclosure suggests a signal which for example is suitable for wake-up radio signalling or other lean signalling.

As traditional On-Off keying, OOK, which is a typical candidate for low-complexity signalling, provides a signal for the on-state and no signal for the off-signal, there is inherently a limitation either in determining timing of the signal or a limitation in usable sequences to use for which timing may be correctly detectable. Here, the timing relates to start and/or end of the transmission. For example, a sequence starting or ending with an off-state may be ambiguously detected. Another example is under intermittent interference where a part of the transmitted sequence is lost, but the channel encoding, if the timing of the transmission is known, may handle the lost information.

It is therefore suggested an amplitude shift keying, ASK, approach, very similar to the OOK approach with two states, but with the off-state substituted by a low-power state which may be distinguished by the receiver from when no signal is provided. This is particularly advantageous for paging sequences and wake-up signals. Advantages of the disclosed signal may also be present for other applications.

According to a first aspect, there is provided a transmitter arranged to transmit binary information using a binary amplitude shift keying where information symbols are represented by a signal including a first power state and a second power state. The first power state has a higher signal power than the second power state. A ratio in powers between the first and second power states is below a first value. The ratio in powers between the first and second power states is above a second value such that the states are distinguishably decodable.

Above the term power is used as if the power would be constant during the duration the signal is in the corresponding power state. It should here be understood that in case the power is varying, the term power could be interpreted in a slightly wider sense, like for instance average power. Alternatively, the metric of interest could be the energy, i.e., the power integrated over a certain time. In what follows, the term power will be used, but for the reasons elaborated on above it should be obvious for a person skilled in the art that this represents a usable metric rather than a power level that must be constant.

The first value may correspond to less than 30 dB, or 30 dB.

The distinguishable decodable ratio in powers between the first and second power states may be a value corresponding to at least 20 dB.

The signal may be arranged to represent a first binary state of a symbol by the first power state and a second binary state of a symbol by the second power state. The first binary state may be represented by the first power state during a portion of a symbol time and the second power state during a rest of the symbol time, and the second binary state may be represented by the second power state during the whole symbol time.

The signal may be arranged such that a first binary state of a symbol may be represented by the second power state during a first part of a symbol time followed by the first power state during a rest of the symbol time, and a second binary state of a symbol may be represented by the first power state during a first part of the symbol time followed by the second power state during a rest of the symbol time.

The signal may be arranged such that a first binary state of a symbol is represented by the second power state during a first portion of a first part of a symbol time followed by the first power state during a rest of the first part of the symbol time, followed by the second power state during the rest of the symbol time, and a second binary state of a symbol is represented by the second power state during a first part of a symbol time, followed by the second power state during a second portion of the symbol time followed by the first power state during the rest of the symbol time.

The signal may be arranged such that the first part of the symbol time is half the symbol time.

According to a second aspect, there is provided a network node arranged to operate in a communication system having one or more wireless devices operatively associated for communication with the network node. The network node comprises a transmitter according to the first aspect.

The network node may comprise a transceiver for communication with the wireless devices, wherein the transceiver is arranged to operate according to a first protocol or radio access technology with the wireless devices, and the transmitter is arranged to operate according to a second protocol or radio access technology with at least a subset of the wireless devices. The network node may comprise a transceiver for communication with the wireless devices, wherein the transceiver is arranged to operate according to a first protocol or radio access technology with the wireless devices, and the transceiver comprises the transmitter.

According to a third aspect, there is provided a method of transmitting binary information using a binary amplitude shift keying where information symbols are represented by a signal including a first power state and a second power state, where the first power state has a higher signal power than the second power state, a ratio in powers between the first and second power states is below a first value, and the ratio in powers between the first and second power states is above a second value such that the states are distinguishably decodable.

The first value may correspond to less than 30 dB, or to 30 dB.

The distinguishable decodable ratio in powers between the first and second power states may be a value corresponding to at least 20 dB.

The signal may be arranged to represent a first binary state of a symbol by the first power state and a second binary state of a symbol by the second power state. The first binary state may be represented by the first power state during a portion of a symbol time and the second power state during a rest of the symbol time, and the second binary state may be represented by the second power state during the whole symbol time.

The signal may be arranged such that a first binary state of a symbol is represented by the second power state during a first part of a symbol time followed by the first power state during a rest of the symbol time, and a second binary state of a symbol is represented by the first power state during a first part of the symbol time followed by the second power state during a rest of the symbol time.

The signal may be arranged such that a first binary state of a symbol is represented by the second power state during a first portion of a first part of a symbol time followed by the first power state during a first part of the symbol time, followed by the second power state during the rest of the symbol time, and a second binary state of a symbol is represented by the second power state during a first part of a symbol time, followed by the second power state during a second portion of the symbol time followed by the first power state during the rest of the symbol time.

The signal may be arranged such that the first part of the symbol time is half the symbol time.

The method may comprise transmitting the signal as a wake-up signal.

The method may comprise transmitting the signal as a control or paging signal.

According to a fourth aspect, there is provided a computer program comprising instructions which, when executed on a processor of a transmitter or network node, causes the transmitter or network node to perform the method according to the third aspect.

### BRIEF DESCRIPTION OF THE DRAWINGS

The above, as well as additional objects, features and advantages of the present disclosure, will be better understood through the following illustrative and non-limiting detailed description of preferred embodiments of the present disclosure, with reference to the appended drawings.

FIG. 1 schematically illustrates an on-off keying signal.

FIG. 2 illustrates a data bit with value representation.

FIG. 3 schematically illustrates a modified value representation.

FIG. 4 illustrates an exemplary wake-up signal structure.

FIG. 5 schematically illustrates power level assignments according to an embodiment.

FIG. 6 is a schematic illustration of a transmitter according to an embodiment.

FIG. 7 is a block diagram schematically illustrating a network node according to an embodiment.

FIG. 8 is a flow chart illustrating a method according to an embodiment.

FIG. 9 schematically illustrates a computer-readable medium and a processing device.

FIGS. 10 to 13 illustrate different arrangements of the signal for a first and a second binary state.

### DETAILED DESCRIPTION

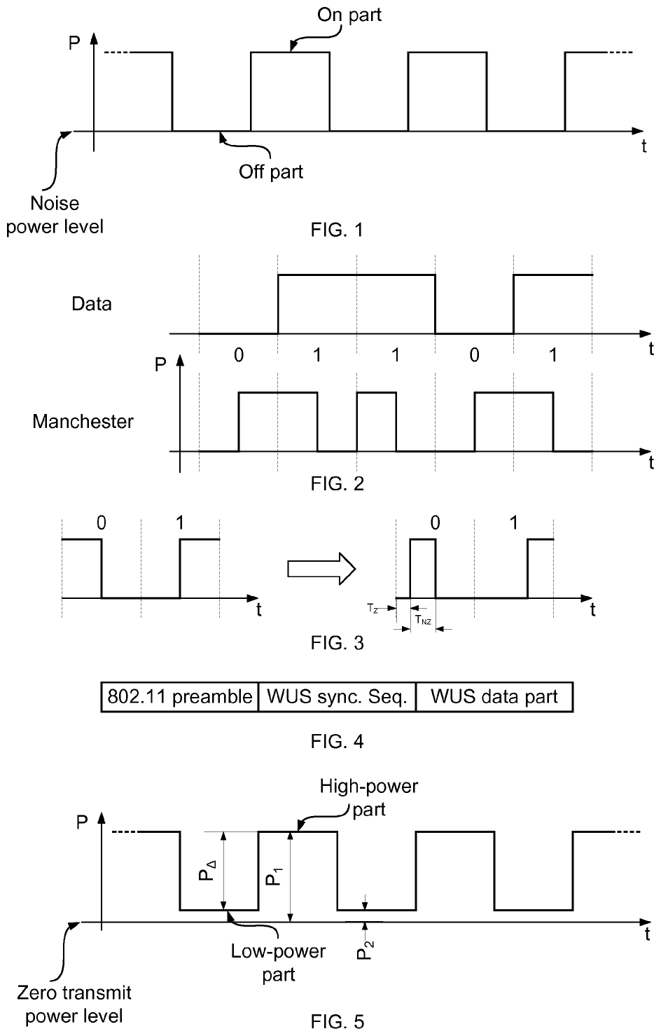

FIG. 1 schematically illustrates an On-Off Keying, OOK, signal, which is a modulation scheme where the presence of a signal represents the ON part or state and the absence of the signal represents the OFF part or state. For example, the ON and OFF parts could represent binary digits, or the transition between ON to OFF state and OFF to ON state could represent binary digits. OOK is considered the simplest form of amplitude-shift keying, ASK that represents digital data at the presence or absence of a signal. In its simplest form, the presence of a carrier for a specific duration represents a binary one, while its absence for the same duration represents a binary zero. Some more sophisticated schemes vary these durations to convey additional information. It is analogous to a unipolar encoding line code. OOK is a suitable modulation to use whenever the power consumption of the receiver is a major concern, as the demodulation can be done non-coherently and with very relaxed requirements on gain control and resolution in the receiver.

In order to decode OOK, the receiver has to estimate which signal level corresponds to the presence of a signal and which signal level corresponds to the absence of a signal. Manchester Coding is a modulation means used to simplify clock recovery and to simplify demodulation by ensuring that the average signal level of the signal carries no information. FIG. 2 illustrates a data bit with value one is represented by, i.e. encoded to, a logical one followed by a logical zero, whereas a data bit with value zero is represented by a logical zero followed by a logical one. Alternatively, the encoding can be swapped so that a data bit with value one is represented by a logical zero followed by a logical one, etc.

Clock recovery is simplified because there will always be a transition from zero to one or vice versa in the middle of each symbol irrespectively of what the data is.

The decoding of the Manchester coded symbol is essentially done by comparing the first and the second half of the symbols and deciding in favour of a logical one if the first half of the symbol has larger power than the second half of the same symbol, or vice versa. Implementation-wise, a metric, m, is generated as

m=r₀−r₁,

where r₀ and r₁ represent the signal during the first and second half of the signalling interval, respectively, see FIG. 2. An estimate î of the k^{th} information symbol, iₖ, is then obtained by just considering the sign of the metric m, i.e., î=1 if m≥0 and î=0 if m<0.

Since the metric, m, is generated by subtracting the second half of the symbol from the first half, the average signal level will be removed and thus have no impact on the metric used for making the decision.

Because of the properties of the Manchester coding when it comes to being insensitive to the average signal level, it is an attractive approach when the alternative would be to estimate a decision threshold for when to decide in favour of a logical one or a logical zero.

For example, Manchester coded OOK is being standardized within the IEEE 802.11ba task group (TG). TG 802.11ba develops a standard for wake-up radios (WUR), targeting to significantly reduce the power consumption in devices based on the 802.11 standard. It is proposed to generate the wake-up signal (WUS) by using an inverse fast Fourier transform (IFFT), as this block is already available in Wi-Fi transmitters supporting e.g. 802.11a/g/n/ac. Specifically, an approach discussed for generating the OOK is to use the 13 sub-carriers in the centre, possibly excluding the DC carrier, and then populating these with some signal to represent ON and to not transmit anything at all to represent OFF.

As an alternative to textbook Manchester coded OOK as shown in FIG. 2, it is feasible to zero-pad a portion of the ON part of the signal to further improve the performance. FIG. 3 illustrates such an approach, where T_{Z} and T_{NZ} denote the time when the ON signal is zero and non-zero, respectively. The potential improvement comes from that the same energy is received during time T_{NZ}, i.e., a shorter time than half the bit time, T_{b}/2, the duration of the ON signal in the classic OOK signal with duty cycle 0.5. Since the noise power is proportional to that time, the signal-to-noise ratio, SNR, is increased correspondingly.

Hypothetically, the SNR can in this way be made infinite. This is impossible in practice though. There are technical and regulatory aspects that may prevent the SNR from becoming arbitrarily large.

FIG. 4 illustrates an example of a wake-up signal structure. The structure of a wake-up signal is proposed to include an 802.11 preamble, followed by a wake-up synchronization sequence, followed by a data signal using OOK.

FIG. 5 illustrates an amplitude shift keying, ASK, approach, which may be compared with the OOK approach with two states, but with the off-state substituted by a low-power state. The ASK approach may enable a receiver to distinguish all parts of a signal sequence from when no signal is provided. It is reasonable to assume that a receiver is able to detect a signal at the low-power state which is 30 dB below the high-power state representing the equivalence to the ON state of OOK, or higher, e.g. somewhere between 20 dB and 30 dB below the high-power state. The ratio between the high-power state and the low-power state is kept high such that the states are distinguishably decodable, preferably with a ratio corresponding to at least 20 dB. Energy considerations further incite to keep the low-power state low. To further address energy considerations, as well as considerations regarding generating interference for other users, duration of high-power state may be adapted, as suggested by some of the embodiments demonstrated below, such that the duration of high-power state is decreased.

In one embodiment, binary amplitude shift keying is used for transmitting binary information. A logical one is transmitted using a first power and where a logical zero is transmitted using a second power, or vice versa. Assuming equal probability of logical ones and logical zeros such that time duration of high-power state and low-power state are equally present in average, referring to the constants 0.5, the average power of the signal is

P_{avg}=0.5·P₁+0.5·P₂,

where P_{avg} is the average power, P₁ is the power applied for the first power, and P₂ is the power applied for the second power. Considering the example where ratio between the first and second powers corresponds to 30 dB, i.e.

$${P}_{Δ} = \frac{{P}_{1}}{{P}_{2}} ,$$

where P_{Δ} is the ratio, we can see that average power P_{avg} is

P_{avg}=0.5·P₁+0.5·P₂=0.5·P₁+0.5·0.001·P₁=0.5005·P₁.

Hence, the increase in average power of letting the low-power state comprise a small signal compared with P₂=0, which would have resulted in P_{avg}=0.5, is neglectable, but providing advantages as discussed above.

As is recognizable by the skilled reader, when considering FIG. 1 and its noise power level and FIG. 5 and its power levels, the signal powers are reasonably chosen such that the P₂ power level is at or above noise power level, and P₁ power level is sufficient for providing a distinguishably decodable signal. In one example, a high-power level P₁ of about 20 dBm and a low-power level P₂ somewhere between 0 dBm and −10 dBm in practice provides a suitable signal for many of the above referenced purposes of the signal.

In one embodiment, where the binary information is Manchester coded, i.e., a logical one is transmitted by a signal whose first part is transmitted with a power P₁ and the second part is transmitted with a power of P₂, and where a logical zero is transmitted by a signal whose first part is transmitted with a power P₂ and the second part is transmitted with a power of P₁, or vice versa, would inherently give the same result independent on the assumption of equal probability of logical ones and logical zeroes due to the nature of the Manchester coding.

As indicated above, further advantages may be given by modifying the signal such that the part with the high-power state is limited in duration. The modification may be made by modifying the signal such that the part that in a corresponding plain OOK is ON, i.e. here in the high-power state, will be split into two parts having different transmission powers, i.e. one part having the high-power state and another part having the low-power state. Consider a parameter α, where

$$α = \frac{{T}_{HP}}{2 \cdot {T}_{s}} ,$$

where T_{HP} is duration of high-power state and T_{S} is duration of a symbol. The parameter α denotes the fraction of time the signal is sent with the higher power, assuming equal distribution of the binary symbols. Average power P_{avg} will thus be

P_{avg}=α·P₁+(1−α)·P₂,

where P₁ is the power applied for the high-power state, and P₂ is the power applied for the low-power state. Here, 0<α≤0.5, and if a ratio between usage of P₁ and P₂ for the symbol including the high-power state selected to e.g. 0.7, i.e. 70% of the symbol time the high-power state is used, the parameter α becomes 0.35, wherein P_{avg} becomes 0.35075·P₁ for a ratio between P₁ and P₂ of 30 dB, Cf the example above with equal duration of high-power and low-power states. Thus, a considerable energy saving is feasible.

The Manchester coding is based on that the signal is coded such that a first binary state of a symbol is represented by the second power state followed by the first power state during a symbol time, and a second binary state of a symbol is represented by the first power state followed by the second power state during the symbol time, and that the first and second parts of the symbol time are half the symbol time. However, a modified code where first and second parts of the symbol time are not half the symbol time, and the high-power parts are made shorter than half the symbol time, may provide energy savings like those demonstrated above.

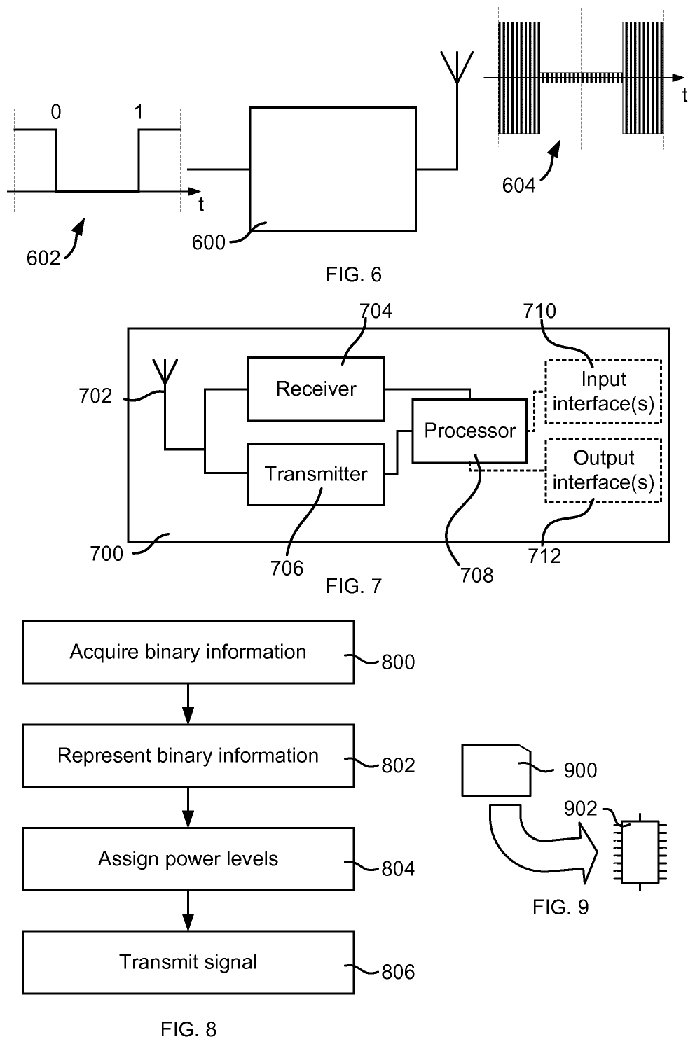

FIG. 6 schematically illustrates a transmitter 600 which is arranged to transmit binary information using the binary amplitude shift keying demonstrated above with reference to the different embodiments. Information symbols 602 are represented by a transmitted signal 604 including at least one of a first power state and a second power state. The transmitter 600 is thus arranged to provide the signal where the first power state has a higher signal power than the second power state, the difference in powers between the first and second power states is below a first ratio, e.g. corresponding to 30 dB, and the difference in powers between the first and second power states is above a second ratio, e.g. corresponding to 20 dB, such that the states are distinguishably decodable by a receiving entity, e.g. a wireless communication device.

FIG. 7 is a block diagram schematically illustrating a network node 700 according to an embodiment. The UE comprises an antenna arrangement 702, a receiver 704 connected to the antenna arrangement 702, a transmitter 706 connected to the antenna arrangement 702, a processing element 708 which may comprise one or more circuits, one or more input interfaces 710 and one or more output interfaces 712. The interfaces 710, 712 can be user interfaces and/or signal interfaces, e.g. electrical or optical. The UE 700 is arranged to operate in a cellular communication network. In particular, by the processing element 708 being arranged to perform the embodiments demonstrated with reference to FIGS. 1 to 6, the network node 700 is capable of representing a signal to be transmitted by the transmitter 706, which signal includes a first power state and a second power state, lower than the first power state, where a ratio in powers between the first and second power states is below a first value and the ratio in powers between the first and second power states is above a second value such that the states are distinguishably decodable by a receiving entity. The transmitter 706 is here to be regarded as either a single transmitter used for both the signal demonstrated above, e.g. wake-up signal, paging signal, control signal, etc., and for other traffic, e.g. associated with a cellular or wireless local area network, or as a transmitter arrangement comprising one transmitter arranged for traffic associated with e.g. a cellular or wireless local area network, and another transmitter arranged and dedicated to provide the signal demonstrated above. The processing element 708 can also fulfil a multitude of tasks, ranging from signal processing to enable reception and transmission since it is connected to the receiver 704 and transmitter 706, executing applications, controlling the interfaces 710, 712, etc.

FIG. 8 is a flow chart schematically illustrating methods according to embodiments. Binary information to be transmitted is acquired 800 and then represented 802 according to any of the above demonstrated approaches to form an ASK signal. The power levels, i.e. P1 and P2 referred to above, are assigned 804. This assignment 804 may be dynamic, e.g. based on estimated channel conditions, or predetermined. The signal is then transmitted 806.

The methods according to the present disclosure is suitable for implementation with aid of processing means, such as computers and/or processors, especially for the case where the processing element 708 demonstrated above comprises a processor handling generation of the signal demonstrated above. Therefore, there is provided computer programs, comprising instructions arranged to cause the processing means, processor, or computer to perform the steps of any of the methods according to any of the embodiments described above. The computer programs preferably comprise program code which is stored on a computer readable medium 900, as illustrated in FIG. 9, which can be loaded and executed by a processing means, processor, or computer 902 of a transmitter or network node to cause it to perform the methods, respectively, according to embodiments of the present disclosure, preferably as any of the embodiments described above. The computer 902 and computer program product 900 can be arranged to execute the program code sequentially where actions of the any of the methods are performed stepwise, or operate according to a real-time approach. The processing means, processor, or computer 902 is preferably what normally is referred to as an embedded system. Thus, the depicted computer readable medium 900 and computer 902 in FIG. 9 should be construed to be for illustrative purposes only to provide understanding of the principle, and not to be construed as any direct illustration of the elements.

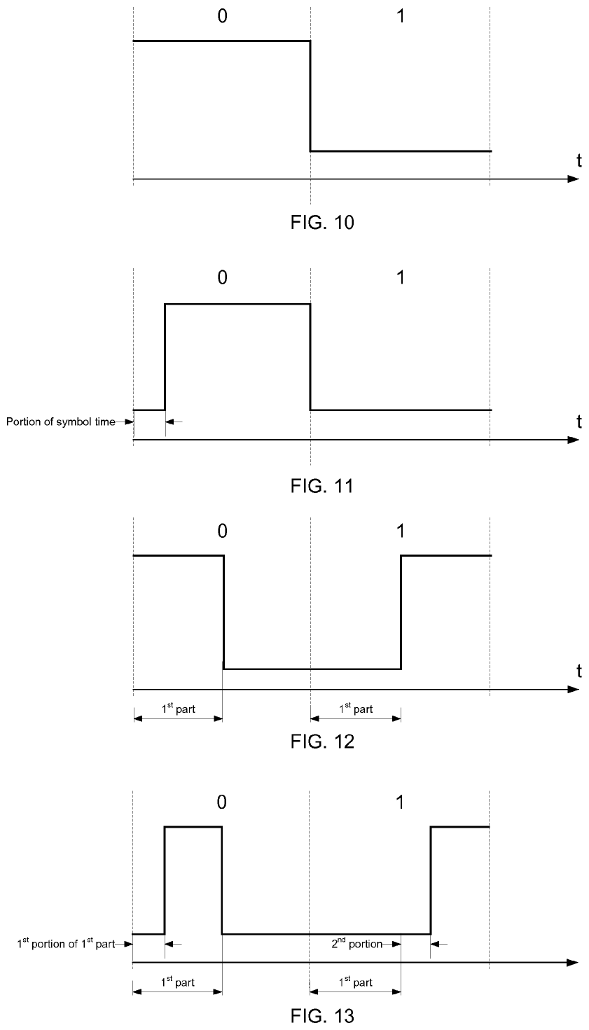

FIGS. 10 to 13 illustrate different arrangements of the signal for a first and a second binary state. In FIGS. 10 to 13, the first binary state is indicated as “0” and the second binary state is indicated as “1”, but the opposite is equally feasible.

FIG. 10 illustrates an example where the signal is arranged to represent a first binary state of a symbol by the first power state and a second binary state of a symbol by the second power state.

FIG. 11 illustrates an example where the first binary state is represented by the first power state during a portion of a symbol time and the second power state during a rest of the symbol time, and the second binary state is represented by the second power state during the whole symbol time.

FIG. 12 illustrates an example where the signal is arranged such that a first binary state of a symbol is represented by the second power state during a first part of a symbol time followed by the first power state during a rest of the symbol time, and a second binary state of a symbol is represented by the first power state during a first part of the symbol time followed by the second power state during a rest of the symbol time.

FIG. 13 illustrates an example where the signal is arranged such that a first binary state of a symbol is represented by the second power state during a first portion of a first part of the symbol time followed by the first power state during a rest of the first part of the symbol time, followed by the second power state during the rest of the symbol time, and a second binary state of a symbol is represented by the second power state during a first part of a symbol time, followed by the second power state during a second portion of the symbol time followed by the first power state during the rest of the symbol time.

In FIGS. 12 and 13, the signal may be arranged such that the first part of the symbol time is half the symbol time. As indicated above, the terms “part” and “portion” of a symbol time are used to distinguish the features and effects thereof, i.e. a “part” is the division of the symbol time used for mimicking some principles of the Manchester code, while “portion” is the division for the further energy savings demonstrated above, where the “portion” usually is smaller than the “part”.

1. A transmitter configured to:
transmit binary information using a binary amplitude shift keying, information symbols being represented by a signal including a first power state and a second power state; and
the first power state has a higher signal power than the second power state;
a ratio in powers between the first and second power states is below a first value; and
the ratio in powers between the first and second power states is above a second value such that the states are distinguishably decodable.

2. The transmitter of claim 1, wherein the first value corresponds to less than 30 dB.

3. The transmitter of claim 1, wherein the distinguishable decodable ratio in powers between the first and second power states is a value corresponding to at least 20 dB.

4. The transmitter of claim 1, wherein the signal is arranged to represent a first binary state of a symbol by the first power state and a second binary state of a symbol by the second power state.

5. The transmitter of claim 4, wherein the first binary state is represented by the first power state during a portion of a symbol time and the second power state during a rest of the symbol time, and the second binary state is represented by the second power state during the whole symbol time.

6. The transmitter of claim 1, wherein the signal is arranged such that a first binary state of a symbol is represented by the second power state during a first part of a symbol time followed by the first power state during a rest of the symbol time, and a second binary state of a symbol is represented by the first power state during a first part of the symbol time followed by the second power state during a rest of the symbol time.

7. The transmitter of claim 1, wherein the signal is arranged such that:
a first binary state of a symbol is represented by the second power state during a first portion of a first part of a symbol time followed by the first power state during a rest of the first part of the symbol time, followed by the second power state during the rest of the symbol time; and
a second binary state of a symbol is represented by the second power state during a first part of a symbol time, followed by the second power state during a second portion of the symbol time followed by the first power state during the rest of the symbol time.

8. The transmitter of claim 6, wherein the signal is arranged such that the first part of the symbol time is half the symbol time.

9. A network node configured to operate in a communication system having at least one wireless devices device operatively associated for communication with the network node, the network node comprising:
a transmitter configured to:
transmit binary information using a binary amplitude shift keying, information symbols being represented by a signal including a first power state and a second power state; and
the first power state has a higher signal power than the second power state;
a ratio in powers between the first and second power states is below a first value; and
the ratio in powers between the first and second power states is above a second value such that the states are distinguishably decodable.

10. The network node of claim 9, further comprising a transceiver for communication with the wireless devices, wherein the transceiver is configured to operate according to one of a first protocol and a first radio access technology with the wireless devices, and the transmitter is configured to operate according to one of a second protocol and a second radio access technology with at least a subset of the wireless devices.

11. The network node of claim 9, comprising a transceiver for communication with the wireless devices, wherein the transceiver is arranged to operate according to one of a first protocol and a first radio access technology with the wireless devices, and the transceiver comprises the transmitter.

12. A method comprising:
transmitting binary information using a binary amplitude shift keying, information symbols being represented by a signal including a first power state and a second power state; and
the first power state has a higher signal power than the second power state;
a ratio in powers between the first and second power states is below a first value; and
the ratio in powers between the first and second power states is above a second value such that the states are distinguishably decodable.

13. The method of claim 12, wherein the first value corresponds to less than 30 dB.

14. The method of claim 12, wherein the distinguishable decodable ratio in powers between the first and second power states is a value corresponding to at least 20 dB.

15. The method of claim 12, wherein the signal is arranged to represent a first binary state of a symbol by the first power state and a second binary state of a symbol by the second power state.

16. The method of claim 15, wherein the first binary state is represented by the first power state during a portion of a symbol time and the second power state during a rest of the symbol time, and the second binary state is represented by the second power state during the whole symbol time.

17. The method of claim 12, wherein the signal is arranged such that a first binary state of a symbol is represented by the second power state during a first part of a symbol time followed by the first power state during a rest of the symbol time, and a second binary state of a symbol is represented by the first power state during a first part of the symbol time followed by the second power state during a rest of the symbol time.

18. The method of claim 12, wherein the signal is arranged such that
a first binary state of a symbol is represented by the second power state during a first portion of a first part of a symbol time followed by the first power state during a first part of the symbol time, followed by the second power state during the rest of the symbol time; and
a second binary state of a symbol is represented by the second power state during a first part of a symbol time, followed by the second power state during a second portion of the symbol time followed by the first power state during the rest of the symbol time.

19. The method of claim 17, wherein the signal is arranged such that the first part of the symbol time is half the symbol time.

20. The method of claim 12, comprising transmitting the signal as a wake-up signal.

21. The method of claim 12, comprising transmitting the signal as a one of a control and a paging signal.

22. A computer storage medium storing an executable computer program comprising instructions which, when executed on a processor of one of a transmitter and a network node, causes the one of the transmitter and the network node to perform a method, the method comprising:
transmitting binary information using a binary amplitude shift keying, information symbols being represented by a signal including a first power state and a second power state; and
the first power state has a higher signal power than the second power state;
a ratio in powers between the first and second power states is below a first value; and
the ratio in powers between the first and second power states is above a second value such that the states are distinguishably decodable.
